(19) United States
(12) Patent Application Publication
(10) Pub. No.: US 2007/0057786 A1
(43) Pub. Date: Mar. 15, 2007

(54) Ferromagnetic threat warning system

(75) Inventors: Richard J. McClure, San Diego, CA (US); R. Kemp Massengill, Leucadia, CA (US); Erwin Holowick, Oakbank (CA)

Correspondence Address: GERALD W. SPINKS, P. O. BOX 5242, GLACIER, WA, 98244, US

(73) Assignee: MedNovus, Inc., Leucadia, CA (US)

(21) Appl. No.: 11/262,488

(22) Filed: Oct. 27, 2005

Related U.S. Application Data
(60) Provisional application No. 60/716,880, filed on Sep. 13, 2005.

(51) Int. Cl. G08B 13/24

(52) U.S. Cl. 340/551

(57) ABSTRACT

An apparatus and method for preventing entry of a ferromagnetic threat object into a no-entry zone of an MRI facility, by attaching a magnet to each threat object, and sensing movement of any such magnet within a pre-selected distance from the no-entry zone. An RFID tag and scanning antenna can be used to sense the presence of a threat object anywhere within the sensing range of the interrogation device, either separately or as an adjunct to the distance detection provided by the magnetic field source and sensor system.

### CROSS REFERENCE TO RELATED APPLICATIONS

This application relies upon U.S. Provisional Patent Application No. 60/716,880, filed on Sep. 13, 2005, and entitled “Ferromagnetic Threat Warning System.”

### STATEMENT REGARDING FEDERALLY SPONSORED RESEARCH OR DEVELOPMENT

Not Applicable

### BACKGROUND OF THE INVENTION

1. Field of the Invention

This invention is in the field of methods and apparati used in pre-screening to prevent entry of ferromagnetic threat objects into the vicinity of a magnetic resonance imaging (MRI) magnet.

2. Background Art

Even small ferromagnetic objects which are inadvertently carried into a magnetic resonance imaging magnet room can become potentially lethal projectiles in the very high magnetic field and high magnetic field gradient surrounding the MRI magnet. Large ferromagnetic objects, such as oxygen tanks, floor scrubbers, and pipe wrenches, pose the threat of great harm to patients undergoing MRI, as well as causing damage to the MRI instrument itself. A disastrous accident occurred to a small boy when an oxygen tank was inadvertently brought into the magnet room, causing his death. Many “near-misses” have occurred, and the majority of MRI centers can relate such potentially dangerous incidents.

Recently issued regulations require the marking of significant ferromagnetic threat objects located in the MRI environment, such as oxygen tanks, furniture, floor scrubbers, vacuum cleaners, etc., in an effort to decrease MRI-related missile threat accidents.

Visual signage placed upon significant threat objects used every day in an MRI center, although better than nothing, does not provide sufficient warning of ferromagnetic threats, especially to staff accustomed to the presence of the equipment. Floor scrubbers, wrenches, oxygen tanks, chairs, tables, gurneys, and even beds, have been propelled rocket-like toward the MRI magnet, with devastating consequences to the MRI imaging equipment, and, tragically, sometimes to patients. As these ferromagnetic threat objects are ubiquitous in MRI centers, more than visual signage is required.

Threat detection systems are known, which detect the presence of a ferromagnetic threat object by sensing a magnetic field which is induced in the threat object by an external field such as the earth's magnetic field. A typical distance at which a ferromagnetic threat object should be detected, in an effective threat detection system, is 8 to 12 feet from the no-entry zone, depending on the architectural configuration of the room. This detection distance can provide adequate warning to prevent passage of the threat object into the protected area. An induced magnetism sensor system alone does not provide sufficient reliability to function as a mission-critical early warning system in the MRI setting. This is because detection of the induced magnetism in the threat object may only occur at 3 feet from the no-entry zone, or even at a lesser distance if the ferromagnetic threat has less induced magnetism. Worse still, detection may even occur after the technician has opened the door to the no-entry zone, allowing passage therein. Detection at this short distance with an induced magnetism sensor system alone may be too late to prevent the ferromagnetic threat, such as an oxygen tank, from entering the magnet room, with potentially disastrous consequences.

A magnetic sensor system detects the magnetic field emanating from a ferromagnetic object when the ferromagnetic object moves and the detection threshold is met. Ferromagnetically-hard materials which have not been permanently magnetized are difficult to magnetize with an external field. Therefore, it is certainly possible that virtually no magnetization will be present in the threat object. As a result, detectability can be minimal, or even absent, with an induced magnetic sensing system alone. Yet, when such a ferromagnetically-hard object is brought into the MRI magnet room, it will most assuredly become magnetized by the huge magnetic field of the MRI magnet, and the object will then be propelled toward the MRI magnet.

Granted, the earth's magnetic field may sometimes provide enough induced magnetization of a ferromagnetic threat object to trigger an alarm in time to prevent entry into the magnet room. However, this small source of external magnetization cannot be reliably counted upon to ensure sufficient induced magnetization for the detectability of all significant ferromagnetic threat objects. This is especially true of ferromagnetically-hard, difficult-to-magnetize, threat objects.

It is also possible that the distant fringing magnetic field of the MRI magnet may supply a magnetic field source outside the MRI magnet room. This fringing field may induce a magnetic field in a threat object, even in spite of shielding to prevent magnetic field transmission beyond the perimeter of the magnet room. However, as with the earth's magnetic field, this may be insufficient to induce enough magnetization in the threat object to trigger an alarm and thereby prevent entry into the magnet room.

It is also known to use ferromagnetic-detecting portals to detect passage of a threat object through the portal aperture. Such portals can improve the detectability of a threat object, but they typically trigger an alarm only when the threat object passes through the portal or doorway.

What is needed, then, is a way of ensuring that oxygen tanks, floor scrubbers, and other significant ferromagnetic threats, are not brought into the magnet room under any circumstances. The present invention provides a method and apparatus for this purpose.

### BRIEF SUMMARY OF THE INVENTION

The present invention employs a signal source attached to every threat object which may be taken into the area of the MRI facility. The signal source can be either a magnetic field source of specified strength, or it can be an RFID tag. The signal generated by either type of source can be considered a “threat signal”, in the sense that it signifies the presence of an object that has been identified as a threat object. In the case of the magnetic field source, the movement of the magnetic field source triggers a magnetic sensing system to activate an alarm at a pre-selected distance. In the case of the RFID tag, the tag is activated by a scanning antenna system when the RFID tag moves into the area scanned by the antenna. The magnetic source embodiment and the RFID embodiment may be employed either separately or together. If desired, a door interlock precluding entry into the no-entry zone is provided. The alarm is triggered well before the ferromagnetic threat object with the affixed signal source passes through the door into the no-entry zone. Triggering when the threat object is in the doorway to the no-entry zone would be too late, as the object would then be actually moving into the no-entry zone. If the no-entry zone is the magnet room, catastrophe would be invited.

In contradistinction to reliance on visual signage and sensing of a magnetic field induced in a threat object, the present invention provides threat alarming with a signal that is generated by a device attached to each threat object. This signal is of a known predetermined magnitude, not limited by the characteristics of the threat object itself, insuring that sensing will occur in a reliable fashion. The alarms can be audible or visible alarms, or both, to warn of the approach of significant ferromagnetic threat objects to a designated no-entry zone, such as the MRI magnet room.

In the preferred embodiment of the present invention, a source of dipole magnetic field, preferably a bar magnet, is attached to each designated ferromagnetic threat object, such as a piece of equipment or furniture. This magnetic field source triggers a sensor system to activate an alarm when the designated ferromagnetic threat with its affixed magnetic field source moves, at a location which is within a pre-selected distance from a designated no-entry zone, such as the magnet room. The sensor system and an alarm system are preferably mounted very close to the door of the designated no-entry zone, and a door interlock can be provided to preclude entry through the door in question. The shape and size of the attached dipole magnetic field source is selected to cause an alarm at a distance which is predetermined to be at the limit of the safe distance from a designated no-entry zone. If sensing at a greater distance is required, a bar magnet with a larger dipole moment is needed.

Preferably, the no-entry zone is the MRI magnetic room itself, which has been designated as Zone IV by the American College of Radiology. Alternatively, the selected no-entry zone can be elsewhere in the MRI center, such as the ante-room to the MRI magnet room. The ante-room to the magnet room is designated Zone III by the American College of Radiology.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a schematic of the magnetic field of a bar magnet having greater length than width;

FIG. 2 is a schematic of the magnetic field of a magnet having equal length and width;

FIG. 3A illustrates different magnet configurations;

FIG. 3B is a schematic of the magnetic field of an electromagnetic coil;

FIGS. 4A and 4B show the use of the magnetic embodiment of the present invention in a first type of facility;

FIG. 5 shows the use of the magnetic embodiment of the present invention in a second type of facility;

FIG. 6 is a schematic of the effect of a magnetic field of a distant object;

FIG. 7 shows the use of the RFID embodiment of the present invention in a first type of facility;

FIG. 8 shows the use of the RFID embodiment of the present invention in a second type of facility;

FIG. 9 shows the use of the RFID embodiment of the present invention in a portal, in a first type of facility; and

FIG. 10 shows the use of the RFID embodiment of the present invention in a portal, in a second type of facility.

### DETAILED DESCRIPTION OF THE INVENTION

In one embodiment, the present invention provides a permanent magnet of sufficient magnetic field strength that detection by a sensing system, and subsequent alarming, is assured upon movement of the magnetic field source, within a pre-selected distance from the no-entry zone. This magnet is attached to the ferromagnetic threat object. Extremely slow or microscopic movement of the threat object might compromise its detectability, but reasonable motion will be detected, such as a person walking an oxygen tank toward the no-entry zone, or a person moving a floor scrubber in the customary fashion. The uncertainty present in sensing a magnetic field induced in a ferromagnetic threat object is eliminated by the present invention, which provides an independent source of sufficient permanent magnetic field strength to ensure alarming. Even ferromagnetically-hard, difficult-to-magnetize materials will be detected with the apparatus and method of the present invention, because it is not necessary to induce a magnetic field in these objects. What assures detection, then, is not the ferromagnetic threat object itself, but the affixed magnetic field source. The affixed magnet is selected to have a dipole magnetic moment which is appropriately sized to be detected by the sensor system, when the magnet moves, at a location which is within a specified distance from the sensor system. This ensures that the threat object will be detected when the magnetic field source is moved toward the sensor system and reaches that specified distance.

In the case of a ferromagnetic threat object which has become significantly magnetized, it is true that the magnetic field of the threat object itself, in combination with the magnetic field of the affixed magnetic field source, may trigger an alarm at a greater distance than that which has been pre-selected. For instance, the alarm may be set off at 15 feet, when the pre-selected alarm-triggering distance is 10 feet. This in no way, however, poses any risk. Triggering at a greater distance than what is pre-determined to be the safe distance is acceptable. The early-warning system of the present invention just activates a little earlier than specified. Problems would occur only if alarm triggering is non-existent, or too late to prevent the ferromagnetic threat object in question from entering the magnet room, and the present invention prevents this.

The preferred alarm incorporates both visual and auditory components. A door interlock connected to the sensing and alarm system, precluding entrance into the no-entry zone, can be provided. The door interlock can be triggered simultaneously with the alarm.

To reduce noise from vibration, it is preferable to mount the sensor system of the present invention on the wall adjacent to the designated door leading into the no-entry zone, such as one foot from the doorframe, rather than on the door itself. Shock mounting of the sensor system can be provided to reduce noise caused by vibrations in the MRI suite emanating from many sources, including trucks passing on a nearby street, or gurneys being wheeled on a floor above the MRI suite.

It will be noted that the present invention differs from the aforementioned ferromagnetic-detecting portals, as the latter only detect passage through the portal aperture. The present invention functions as an early warning system which does not require passage through a portal. The sensor system triggers an alarm caused by movement of the magnetic field source relative to the sensor system, with the alarm being triggered whenever such movement occurs within a pre-selected distance from the no-entry zone. When the threshold magnetic field strength sensed by the sensor system has been reached, movement of the magnetic source activates the alarm. The present invention is calibrated to detect the designated ferromagnetic threat object long before it passes through a doorway. That is, ferromagnetic threat objects with the affixed magnetic field source moving anywhere in the room can trigger an alarm, provided that the criteria for alarming are met, rather than triggering an alarm only when a threat object passes through a portal or a doorway.

The desired maximum distance for alarm triggering is set by moving the magnetic field source toward the sensor system. Then, when the magnetic field source's magnetic field reaches a threshold of the sensor, the sensor system triggers an alarm. If it is noted that the alarm occurs at an unacceptable distance from the no-entry zone, such as too close, or too far away, either the sensor's alarm-triggering threshold can be adjusted, or a magnetic field source with different magnetic parameters can be utilized, such that the desired distance for triggering the alarm is assured.

Magnetic field sources, such as bar magnets of various sizes and shapes, or, coil configurations with appropriate magnetic fields, can be selected to achieve the alarm-triggering distance which is desired for the MRI center in question. If the desired distance is 15 feet, the magnetic field source affixed to the ferromagnetic threat object should have different magnetic parameters than if the pre-selected distance is 8 feet. The appropriate pre-selected distance depends upon the architectural configuration of each particular MRI center. For instance, if the no-entry zone to be guarded is the magnet room, an MRI center with a small ante-room to the MRI magnet room requires a shorter trigger-alarm distance than an MRI center with a large ante-room to the MRI magnet room. In a very compact MRI center, the alarm distance could, of necessity, be reduced to 4 to 6 feet; that is, the alarm distance could be reduced to the appropriate distance for that particular center. A magnetic field source with a larger dipole magnetic moment is detected at a greater distance than a magnetic field source with a smaller dipole magnetic moment, even if the magnetic field sources have equivalent volumes. Any magnetic field source may be used for the present invention, as long as it can be appropriately attached to the ferromagnetic threat object in question, and as long as it is sensed in such a way that the alarm is triggered at the desired distance from the no-entry zone. To avoid unnecessary complexity and uncertainty, a permanent magnet source, such as a bar magnet, is preferred.

For oxygen tanks which are returned to the refilling company after use, the magnetic field source can be removably attached. Strong plastic tie-rods, or cable ties, may be used for this purpose. For any significant ferromagnetic threat object which is not returned to a vendor after use, but rather resides continuously in the MRI suite, such as ferromagnetic furniture, floor scrubbers, wrenches, vacuum cleaners, ferromagnetic wheelchairs, ferromagnetic gurneys, etc., the magnetic field source may be permanently affixed, and, in fact, this is recommended.

It is preferred that the permanent magnetic field source's exterior be red in color, as this color indicates that the object in question is not safe to be transported into the magnet room. Appropriate labeling, such as MRI UNSAFE—DO NOT TAKE INTO MRI MAGNET ROOM, can be furnished.

As an alternative to a single bar magnet, the magnetic field source can be an array of one or more bar magnets. Alternative embodiments for supplying a magnetic field source include an electromagnetic coil configuration. The coil's power supply, however, will need recharging, or replacing, which of course is not required with a permanent magnet source. A coil configuration with a power supply may be desirable, however, if an alert-light system on the ferromagnetic threat object is desired. In this embodiment, a light source receiving power from the coil's power supply could flash at a timed interval, such as every two seconds, signifying that the threat object is not safe for use in the magnet room.

The magnetic sensing system may use any sensor which detects a moving magnetic field. This can be a single sensor, or sensor system, or an array of two or more sensors, or two or more sensor systems, and the sensors may be configured as gradiometers.

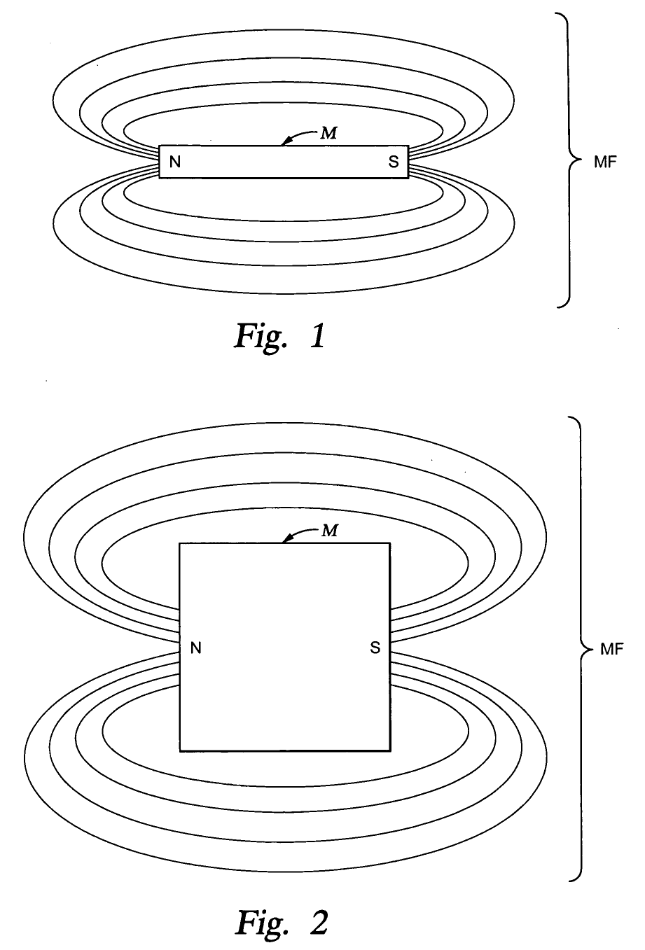

FIG. 1 depicts the magnetic field MF of a dipole magnet field source, such as a bar magnet M. N indicates the north pole of the magnet M, and S indicates the south pole of the magnet. The strength of the magnetic field varies inversely with the cube of the distance from the magnet. For instance, the magnetic field at 6 feet from the magnet is 2×2×2, or 8 times, stronger than the magnetic field at 12 feet from the same magnet.

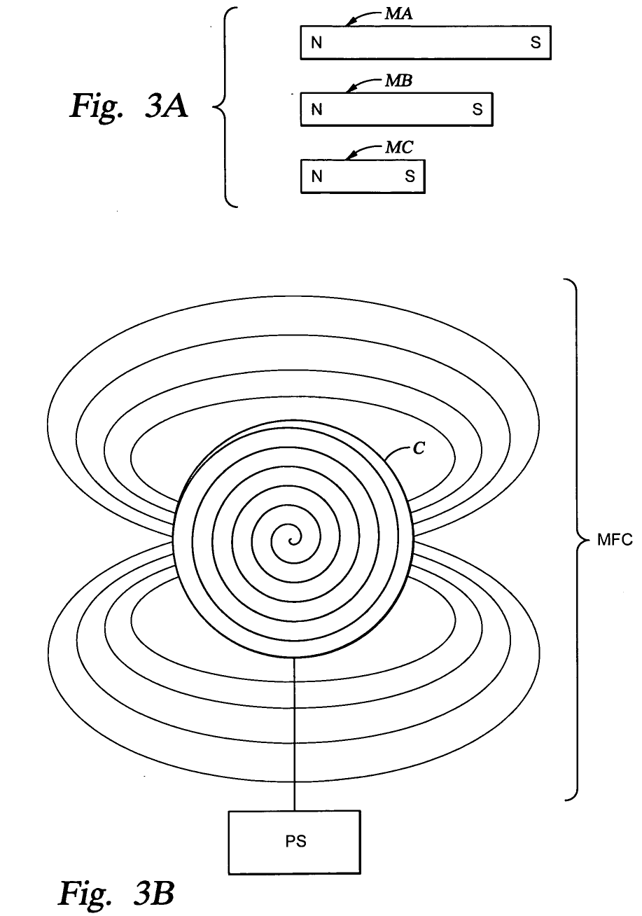

A typical bar magnet has a more extensive magnetic field than a magnet whose length-to-diameter radio is smaller, and is, therefore, generally preferred when the distance pre-selected to trigger an early warning alarm is greater. FIG. 2 shows the magnetic field MF of a magnet of equal length and width. The magnetic field MF of this magnet at a given distance is smaller than the magnetic field of a bar magnet of equivalent volume, but having a length significantly greater than its width. For instance, at a distance of 10 feet from the magnet, the magnetic field of the magnet which is equal in length and width may be only half that of an elongated bar magnet of the same volume, or even less.

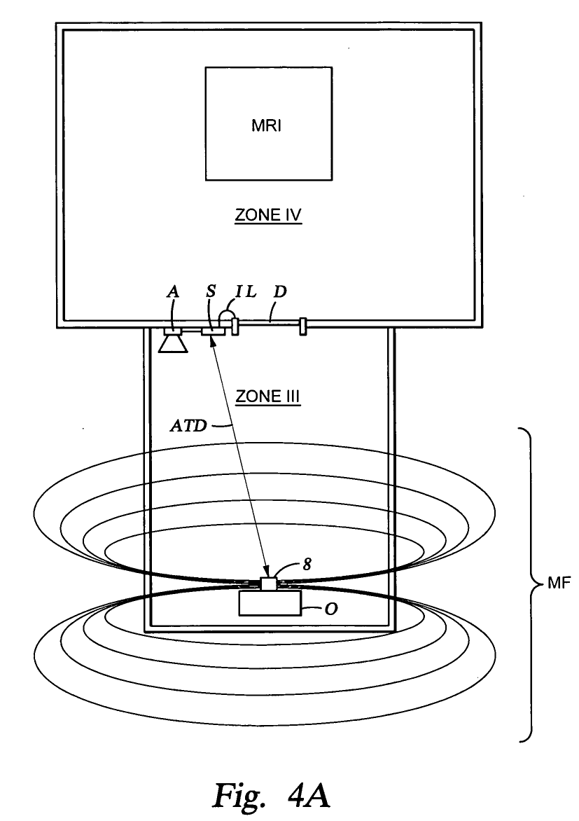

FIG. 3A shows a variety of permanent magnets, pre-selected for a given alarm distance. For any given MRI center, once the desired alarm distance is determined, similarly-sized magnets are then placed on all known ferromagnetic threat suspects, such as oxygen tanks, floor scrubbers, gurneys, and wheelchairs. A first magnet MA would be selected for a greater alarm-triggering distance than a second magnet MB, which is selected for a lesser alarm-triggering distance than the first magnet MA, but a greater alarm-triggering distance than a third magnet MC. If the electromagnetic coil embodiment is used, as shown in FIG. 3B, the strength and shape of the magnetic field MFC generated by the coil configuration C depends upon the configuration of the coil C and its electrical properties. So, the appropriate coil configuration C and power supply PS must be chosen to trigger an alarm at the pre-selected alarming distance.

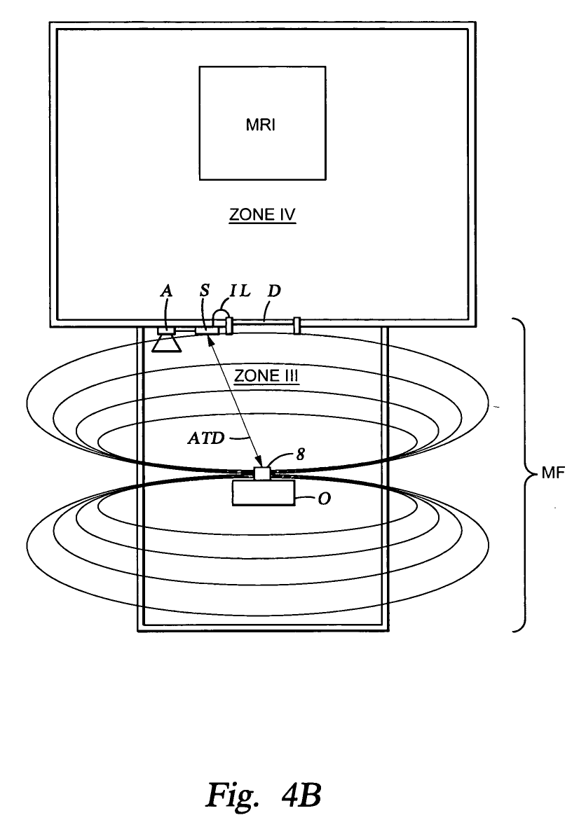

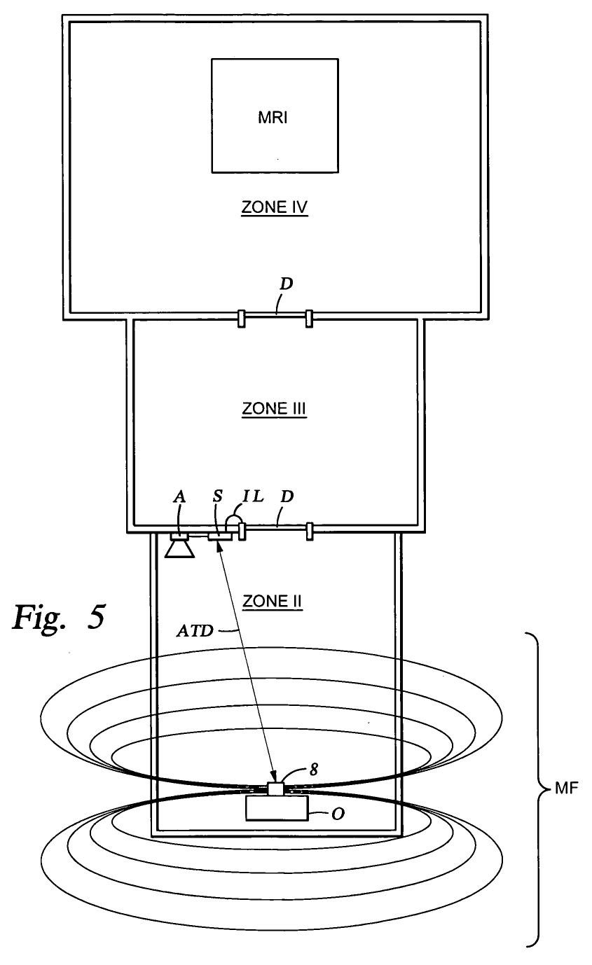

FIGS. 4A and 4B show the architecture of a typical MRI center. The magnet room (Zone IV) houses the MRI instrument itself, and it is in this zone where missile-threat accidents must be prevented. The magnet room's ante-room (Zone III) is designated in the preferred embodiment to be the location in which the early alarming of the present invention occurs. Alternatively, another zone can be chosen, such as a corridor entering the MRI suite itself, or the ante-room to the ante-room (Zone II), as shown in FIG. 5.

Returning to FIGS. 4A and 4B, the ferromagnetic threat object O, for instance an oxygen tank, has affixed to it the magnetic field source 8 of the present invention. Movement of the magnetic field MF of the magnetic field source 8 is detected by the sensor system S, triggering the alarm A, but only when the strength of the magnetic field MF at the sensor system S reaches the pre-designated magnetic field strength which meets the sensor system's requirements for triggering the alarm A. For instance, if the pre-selected alarm-triggering distance ATD is 10 feet, no alarm occurs at 14 feet. But, once the magnetic field source 8 attached to the ferromagnetic threat object O is moved toward the sensor system S to within the pre-selected alarm-triggering distance ATD, the alarm A is triggered. The preferred alarm A has both visual and auditory components. An automatic door interlock IL between the sensor system S and the door D can be provided. The preferred location for the sensor system S and the alarm A is at, or near, the door D leading into the no-entry zone.

FIG. 4A shows the ferromagnetic threat object O with its affixed magnetic field source 8. At the distance shown by the dashed line, the strength of the magnetic field MF is insufficient to cause the sensor system S to activate the alarm A, as the alarm-triggering distance ATD has not been reached.

As shown in FIG. 4B, when the ferromagnetic threat object O, with its affixed magnetic field source 8, is moved closer, however, the sensor system S triggers the alarm A when the magnetic field source 8 is moved, at a location which is within the distance from the sensor system S, shown by the dashed line. The distance shown by the dashed line coincides the with pre-selected alarm-triggering distance ATD.

It should be noted that the magnetic field MF established by the magnetic field source 8 does not degrade magnetic resonance imaging quality. Most MRI centers shield their magnet room (Zone IV) to contain, as much as possible, the magnetic field emanating from the MRI magnet. This shield works not only to contain the magnetic field from the MRI magnet, but also acts a barrier to any incoming magnetic field MF from the magnetic field source 8. Even without shielding, however, the field strength of the magnetic field source 8 is insufficient to cause magnetic resonance imaging degradation.

As stated herein, many MRI centers are close to large moving ferromagnetic objects, such as moving elevators, or cars moving in an underground parking garage, or on a nearby street. To avoid the unwanted triggering of false alarms from such distant ferromagnetic sources, MRI facilities confronting these situations can benefit greatly from the use of sensors configured as gradiometers.

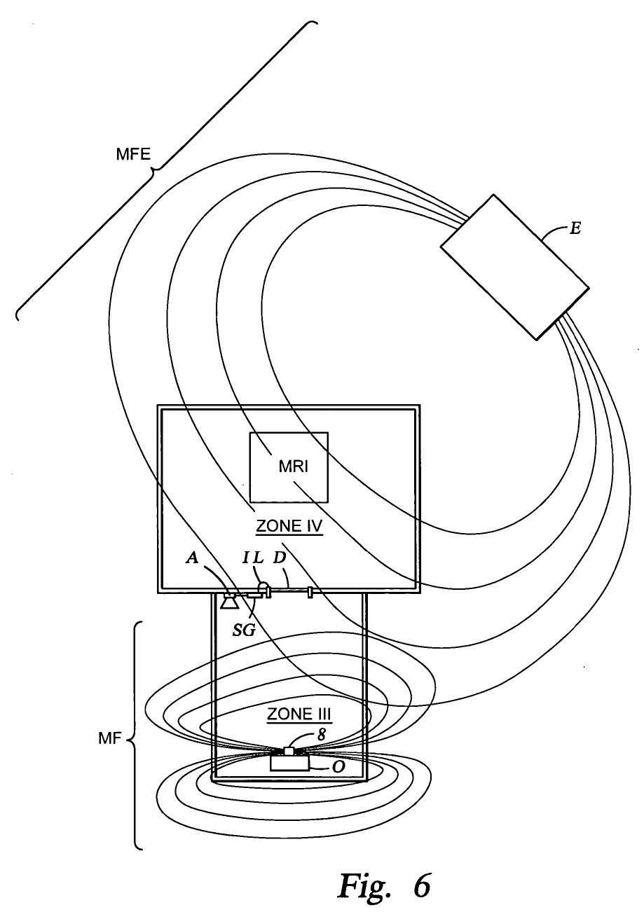

FIG. 6 shows an MRI facility in close proximity to an elevator E and the magnetic field MFE emanating from this elevator E. As each sensor comprising a gradiometer SG receives essentially the same magnetic signal from the magnetic field MFE of the distant ferromagnetic object, in effect, cancellation of this distant signal occurs electronically, and the distant ferromagnetic object, such as the moving elevator E, is not detected. As this elevator, although ferromagnetic, is not a threat object, non-detection of the moving elevator is desirable, to avert false alarms. Although distant, non-threat, ferromagnetic objects do not cause an alarm in such a system, it is necessary that movement of a true ferromagnetic threat object O relative to the sensor system S should trigger the alarm A at the appropriate distance. This alarm can occur because the sensors S comprising the gradiometer configuration SG each receive a different signal from the moving magnetic field source 8 affixed to the ferromagnetic threat object O. The received magnetic field MF signal imbalance, then, triggers the alarm A at the pre-selected alarm-triggering distance ATD.

In some instances, the magnetic source utilized in the present invention may be attached to each threat object only as it enters the area of the MRI facility within a hospital, since it may be undesirable to have multiple magnetic sources in other areas of the hospital, such as near electronic equipment. It is recognized that a staff member may inadvertently forget to affix the magnetic field source to a significant ferromagnetic threat object at the MRI area, including those ferromagnetic threat objects which come and go from the MRI facility itself. An oxygen tank is an example. When an oxygen tank is depleted, it is returned for refilling, and upon refilling, it is often transported to a completely different facility. This means that an MRI facility may receive different oxygen tanks every time they are refilled. In large hospitals, in fact, oxygen tanks go to a number of different areas within the hospital, such as to the emergency room, to the intensive care unit, to the cardiac care unit, to the surgical recovery suite, and to the MRI facility. Only within the MRI facility does a ferromagnetic oxygen tank pose a potential threat.

Either as an alternative to the magnetic sensing system, or to ensure that the magnetic sensing system is faithfully employed, a Radio Frequency Identification System (RFID) alert tag can be permanently affixed upon all appropriate ferromagnetic threat objects brought into the hospital, such as ferromagnetic beds and gurneys, and other furniture or equipment. If for some reason a permanent RFID tag is not suitable, such as possibly on oxygen tanks, the RFID alert tag can be releasably affixed. Attachment of the RFID tags can occur when the oxygen tanks are unloaded at the loading dock of a hospital, for instance, and then if necessary, the RFID tag can be removed when the oxygen tank exits the facility.

The RFID tag is detected at a designated doorway area to a controlled zone outside the no-entry zone, such as at the entry door to the MRI facility itself, and an alarm is triggered. If it is then necessary to admit the tagged threat object into the controlled zone, this alarm can be a signal to the MRI personnel to affix the magnetic field source described herein to the threat object. The purpose of the RFID tag, in this instance, is to ensure that the magnetic field source of the present invention is applied to all significant ferromagnetic threat objects entering the MRI facility from the outside, to ensure detection of the approach of any threat object within a selected distance from the door to the no-entry zone.

Since a busy hospital typically brings patients on beds and wheelchairs to the hospital's magnetic resonance imaging facility, the RFID alert tag should be affixed in advance to all major ferromagnetic threat objects, such as all the beds and the wheelchairs in the environs of the hospital. Subsequently, if a tagged bed or wheelchair is brought to the entrance of the MRI facility, an alarm is triggered, indicating that these objects are MRI-unsafe, and alerting personnel to the need to attach a magnetic source to any threat object which must be admitted to the facility.

As this embodiment of the invention is not magnetic, false alarms are not triggered by large moving ferromagnetic objects in the vicinity, such as moving elevators, or cars moving in an underground parking garage or on a nearby street.

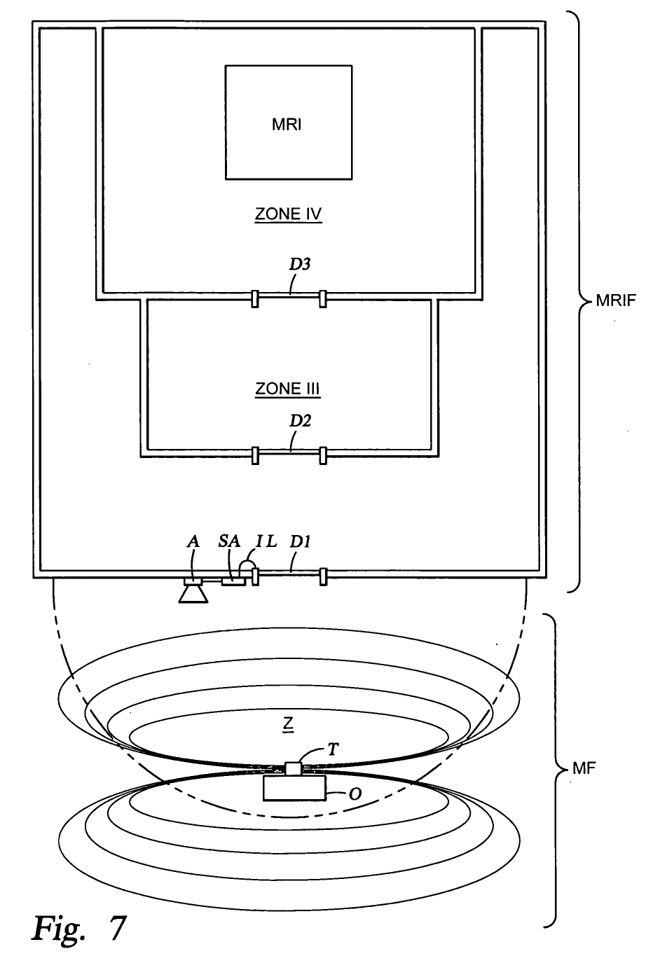

FIG. 7 shows the perimeter of the MRI facility MRIF. In the vicinity of the entry door D is a scanning antenna system SA of the RFID system, which sends out radio-frequency signals. If a ferromagnetic threat object O with its attached RFID tag T enters within the detection zone Z, outlined by the dashed line, the RFID tag T is awakened, and transmission ensues from the RFID tag T back to the scanning antenna system SA. The detection zone Z identifies the area where the field of the scanning antenna system SA is detected by the RFID tag T. The size of the detection zone Z need not be calibrated for a specific distance, but it must control access to the door D. An alarm A is then activated by the scanning antenna system SA, preferably incorporating both visual and audio components. A door interlock IL between the scanning antenna system SA and the entry door D can be provided, automatically precluding entry into the controlled zone of the MRI facility MRIF. This door interlock IL can be manually defeated by staff personnel after the magnetic field source embodiment of the present invention can be affixed to the ferromagnetic threat object O just prior to its being brought into the MRI facility MRIF, and the threat object O can then be brought inside the MRI facility MRIF. Or, alternatively, the magnetic field source embodiment of the present invention can be affixed to the ferromagnetic threat object O immediately after it has been brought into the MRI facility MRIF, but long before it approaches the MRI magnet room, Zone IV. Door D2 is the door to the ante-room, Zone III, and door D3 is the door to the magnet room, Zone IV. The magnetic field source embodiment of the present invention as described herein then protects against entry of the ferromagnetic threat object O into the magnet room.

Alternatively, the corridor of the MRI facility, or any other zone which controls entry into a no-entry zone can have an RFID system which triggers when an RFID-tagged threat object is brought into the controlled zone. This is an embodiment of the present invention which does not involve the attachment of a magnetic field source to the ferromagnetic threat object in question. This embodiment can be used to prevent all entry of threat objects into the controlled zone, regardless of distance from the entry into the no-entry zone. A door interlock to the no-entry zone can be provided, which then becomes locked when the threat object enters the controlled zone and the RFID system triggers the alarm. The alarm can have both visual and/or auditory components. Appropriate labeling, preferably against a red background, such as MRI UNSAFE—DO NOT TAKE INTO MRI MAGNET ROOM, can be furnished.

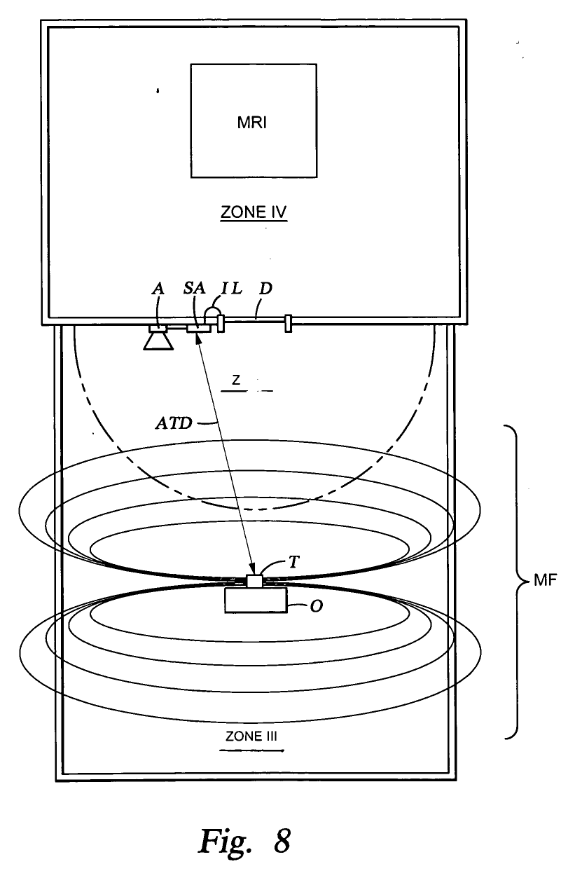

FIG. 8 shows the RFID embodiment of the present invention used inside the controlled zone itself, such as, for example, in Zone III, which is the ante-room to the magnet room, Zone IV. The RFID tag T is affixed to a known ferromagnetic threat object O. When this ferromagnetic threat object O enters within the detection zone Z inside the controlled zone, the radio-frequency signal transmitted by the scanning antenna system SA near the door D leading into the magnet room is detected by the RFID tag T. The RFID tag T is then activated to transmit back to the scanning antenna system SA. It should be noted that the detection zone Z is not a calibrated area, and it may encompass the entire controlled zone of the ante-room, in which case the signal from the scanning antenna system SA is detected as soon as the threat object enters the ante-room. An alarm A is triggered when the signal from the scanning antenna system SA is detected. An automatic door interlock IL can be provided, which precludes entry of the ferromagnetic threat object O with its affixed RFID tag T into the magnet room, Zone IV. This is an embodiment of the present invention which does not involve the attachment of a magnetic field source to the ferromagnetic threat object in question.

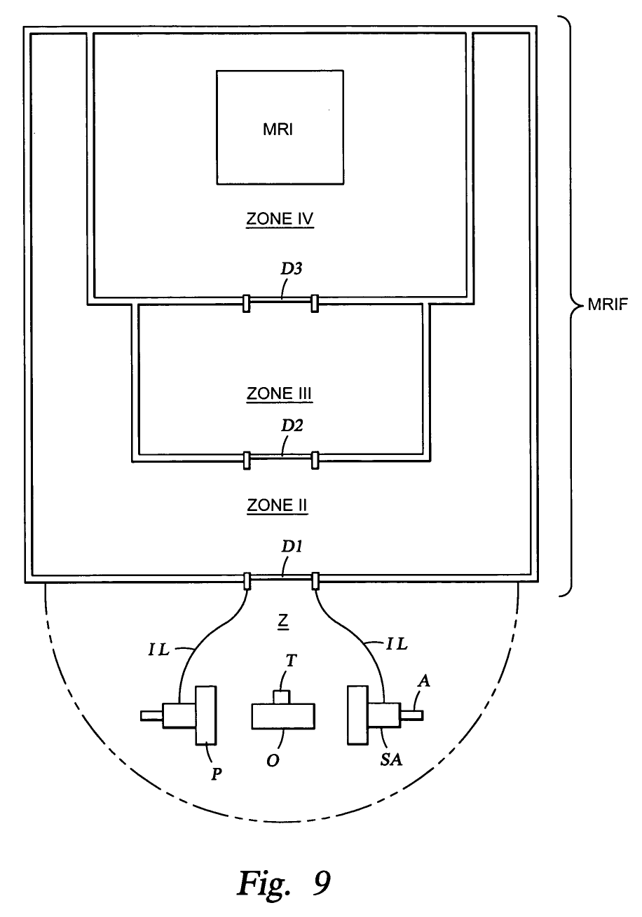

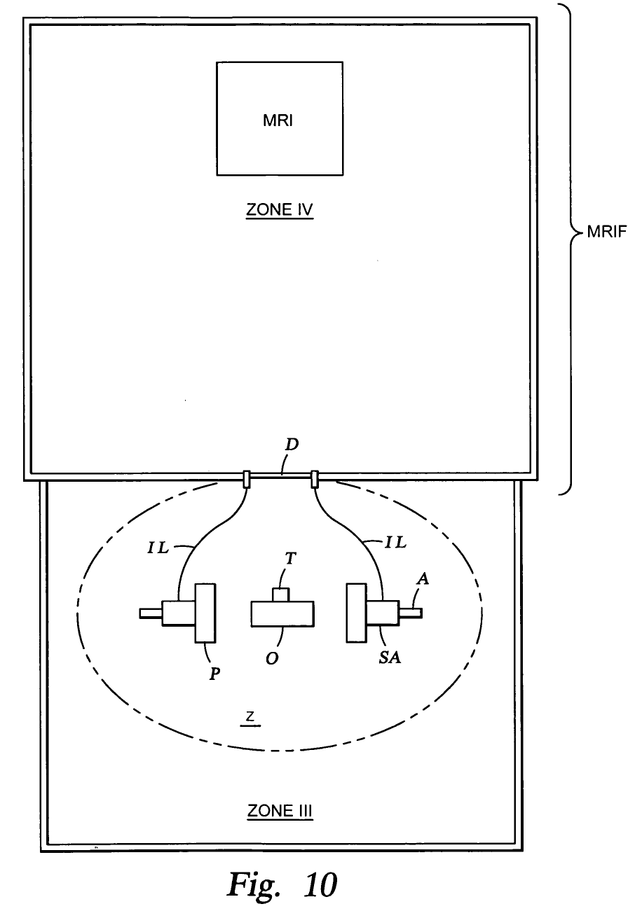

Further, an alarm can be triggered when the RFID tag passes through an RFID portal P with a scanning antenna system SA and an alarm system A, such as just outside the door to the MRI facility, as shown in FIG. 9. The alarm is, preferably, not only auditory, but also visual, and a door interlock IL can be provided.

Alternatively, the portal embodiment shown in FIG. 9 can be used within the MRI ante-room, Zone III, outside the magnet room, Zone IV.

Preferably, the RFID tag has no batteries, with the necessary energy coming from the signal received from the scanning antenna. On the other hand, if a larger detection zone Z is warranted, an RFID tag with long-life batteries can be employed.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

We claim:

1. An apparatus for excluding ferromagnetic threat objects from a threatened area, comprising:
a signal source adapted to be attached to a ferromagnetic threat object, said signal source being adapted to generate a threat signal;
a signal detector mountable at a selected location near a threatened area, said signal detector being adapted to sense said threat signal from said signal source; and
an alarm system adapted to activate when said signal detector senses said threat signal.

2. The apparatus recited in claim 1, wherein:
said signal source comprises a magnetic source;
said threat signal comprises a magnetic field established by said magnetic source; and
said signal detector comprises a magnetic detector, said magnetic detector being adapted to sense movement of said magnetic field when said magnetic field is at or above a magnetic field strength signifying that said threat object is within a selected distance from said magnetic detector.

3. The apparatus recited in claim 2, wherein said magnetic source comprises a permanent magnet.

4. The apparatus recited in claim 2, wherein said magnetic source comprises an electromagnetic coil.

5. The apparatus recited in claim 2, further comprising:
a first radio frequency processor adapted to attach to said ferromagnetic threat object; and
a second radio frequency processor mountable at a selected location near said threatened area;
wherein said second radio frequency processor is adapted to transmit a radio frequency scanning signal;
wherein said first radio frequency processor is adapted to receive said scanning signal from said second radio frequency processor and transmit a radio frequency return signal; and
wherein said second radio frequency processor is adapted to receive said return signal and detect the presence of said ferromagnetic threat object.

6. The apparatus recited in claim 5, wherein:
said first radio frequency processor comprises an RFID tag; and
said second radio frequency processor comprises an RFID scanning antenna system.

7. The apparatus recited in claim 1, further comprising a door interlock adapted to lock a door into a no-entry zone, when said signal detector senses said threat signal from said signal source.

8. The apparatus recited in claim 1, wherein:
said signal source comprises a first radio frequency processor adapted to attach to said ferromagnetic threat object; and
said signal detector comprises a second radio frequency processor mountable at a selected location near said threatened area;
wherein said second radio frequency processor is adapted to transmit a radio frequency scanning signal;
wherein said first radio frequency processor is adapted to receive said scanning signal from said second radio frequency processor and transmit a radio frequency threat signal; and
wherein said second radio frequency processor is adapted to receive said threat signal and detect the presence of said ferromagnetic threat object.

9. The apparatus recited in claim 8, wherein:
said first radio frequency processor comprises an RFID tag; and
said second radio frequency processor comprises an RFID scanning antenna system.

10. A method for excluding ferromagnetic threat objects from a threatened area, comprising:
attaching a signal source to a ferromagnetic threat object;
mounting a signal detector at a selected location near a threatened area;
generating a threat signal with said signal source;
sensing said threat signal from said signal source with said signal detector; and
activating an alarm system when said signal detector senses said threat signal.

11. The method recited in claim 10, wherein:
said attaching comprises attaching a magnetic source;
said mounting comprises mounting a magnetic detector;
said generating comprises generating a magnetic field with said magnetic source;
said sensing comprises sensing movement of said magnetic field with said magnetic detector, when said magnetic field is at or above a magnetic field strength signifying that said threat object is within a selected distance from said magnetic detector.

12. The method recited in claim 11, further comprising:
attaching a first radio frequency processor to said ferromagnetic threat object; and
mounting a second radio frequency processor at a selected location near said threatened area;
said method further comprising:
generating a radio frequency scanning signal with said second radio frequency processor;
receiving said radio frequency scanning signal with said first radio frequency processor;
activating said first radio frequency processor with said radio frequency scanning signal, thereby causing said first radio frequency processor to generate a radio frequency return signal; and
receiving said radio frequency return signal with said second radio frequency processor to thereby detect the presence of said ferromagnetic threat object.

13. The method recited in claim 10, further comprising activating a door interlock to lock a door into a no-entry zone, when said signal detector senses said threat signal from said signal source.

14. The method recited in claim 10, wherein:
said attaching comprises attaching a first radio frequency processor; and
said mounting comprises mounting a second radio frequency processor;
said generating comprises generating a radio frequency threat signal with said first radio frequency processor;
said method further comprising:
generating a scanning signal with said second radio frequency processor;
receiving said scanning signal with said first radio frequency processor;
activating said first radio frequency processor with said scanning signal, thereby causing said first radio frequency processor to generate said threat signal.
